(19) United States
(12) Patent Application Publication
(10) Pub. No.: US 2006/0098665 A1
(43) Pub. Date: May 11, 2006

(54) Systems and methods for communicating with bi-nodal network elements

(75) Inventor: Matthew Joseph Quick, Herndon, VA (US)

Correspondence Address: CROWELL & MORING LLP;INTELLECTUAL PROPERTY GROUP, P.O. BOX 14300, WASHINGTON, DC, 20044-4300, US

(73) Assignee: NEXTEL COMMUNICATIONS, INC., Reston, VA (US)

(21) Appl. No.: 11/243,999

(22) Filed: Oct. 6, 2005

Related U.S. Application Data
(60) Provisional application No. 60/615,951, filed on Oct. 6, 2004.

(51) Int. Cl. H04L 12/56; H04L 12/28

(52) U.S. Cl. 370/401

(57) ABSTRACT

Systems and methods for communicating with bi-nodal network elements are provided. A single address is shared between both nodes of a bi-nodal network element. When packets are transmitted from either one of the nodes of the bi-nodal network element, the single address is employed as the source address of the packet. When packets are transmitted to either one of the nodes of the bi-nodal network element, the single address is employed as the destination address of the packet.

The present application claims priority under 35 U.S.C. § 119 to U.S. Provisional Application No. 60/615,951, filed Oct. 6, 2004, the entire disclosure of which is herein expressly incorporated by reference.

### BACKGROUND OF THE INVENTION

There are a variety of different types of communication networks. One type of communication network uses packets to communicate between various network elements. These packets include a header portion and a payload portion. The header portion includes, among other information, a destination address for the packet. Some packets also include a source address in the header portion of the packet identifying the network element that sent the packet. However, the arrangement of some networks requires changes to the source and destination addresses in packets. For example, due to the limited number of addresses available under Internet Protocol (IP), and to protect network elements that are coupled to the Internet through a private network, these network elements employ IP addresses that are not publicly available. Specifically, when packets are sent from these network elements, a network address translation device will replace the private network address as the source address in the header portion of the packet with a public IP address and port. Similarly, packets destined for network elements located on private networks have a destination address and port on the network address translation device, which replaces the destination address with the actual destination address of the network element.

### SUMMARY OF THE INVENTION

In order to provide high availability, many networks are implementing various types of redundancy into the networks. However, some types of redundancy can result in addressing problems. For example, one type of redundancy currently implemented is redundant routers. Redundant routers are typically implemented with two or more routers, where one router is in an active state and the other routers are in a standby state. In order to handle addressing problems, a variety of protocols have been developed to support redundant routers, such as Cisco Systems proprietary Hot Swappable Router Protocol (HSRP) and the Internet Engineering Task Force (IETF) open standard Virtual Router Redundancy Protocol (VRRP). In both of these protocols a single IP address represents all of the routers of a router group.

Although there are currently protocols available for supporting redundant routers, there are not currently protocols or other solutions for other types of network elements, such as bi-nodal network elements requiring high availability network connections. These bi-nodal network elements can be used to provide services to a communication carrier. Accordingly, the present invention provides systems and methods for minimizing the number of host routes in the carrier network while also simplifying addressing of bi-nodal network elements as viewed from the carrier network. A bi-nodal network element includes two or more nodes, each with their own address. Because each node has its own address, other network elements attempting to communicate with the bi-nodal network element will have to select one of the two addresses. The use of multiple external addresses for a bi-nodal network element is undesirable because it exposes external nodes within the carrier network to malfunctions of the bi-nodal network element (e.g., software errors and insanity impacts) and opens the bi-nodal network element to possible security breaches due to hacking from the carrier network.

In view of the above-identified and other deficiencies of conventional systems, the present invention provides systems and methods for employing a single address for routing packets to and from a bi-nodal network element. Providing a single address for a bi-nodal network element provides security protection to embedded carrier IP packet data networks because the internal bi-nodal network element architecture remains unexposed. Additionally, the present invention increases network element (NE) availability through redundant interface connections, redundant virtual local area networks (VLANs), routing isolation, and advertisement of a single host interface IP address (representing both Node 1 and Node 2) to the carrier network for outbound packets arriving within the carrier's signaling intranet from any of four (4) Fast Ethernet interfaces. The present invention allows greater network element availability and resiliency, tying directly to an optimized end-user experience of the network service provided by the bi-nodal network element being continuously available. From a network perspective, the present invention increases network and network element availability leading to higher mean time between failure (MTBF) and minimization of maintenance due to failures. Additionally, the number of host routes required within the carrier network is minimized through the representation of two or more nodes via a single IP address. This in turn leads to a decreased router memory and processing capability requirement leading to the potential hardware cost savings for routers within the carrier network.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 illustrates an exemplary system in accordance with one embodiment of the present invention;

FIG. 2 illustrates an exemplary system in accordance with another embodiment of the present invention;

FIG. 3 illustrates a logical view of the addressing of the bi-nodal network element in accordance with exemplary embodiments of the present invention; and

FIGS. 4a and 4b illustrate exemplary methods for communicating with a bi-nodal network element in accordance with the present invention.

### DETAILED DESCRIPTION OF THE PREFERRED EMBODIMENTS

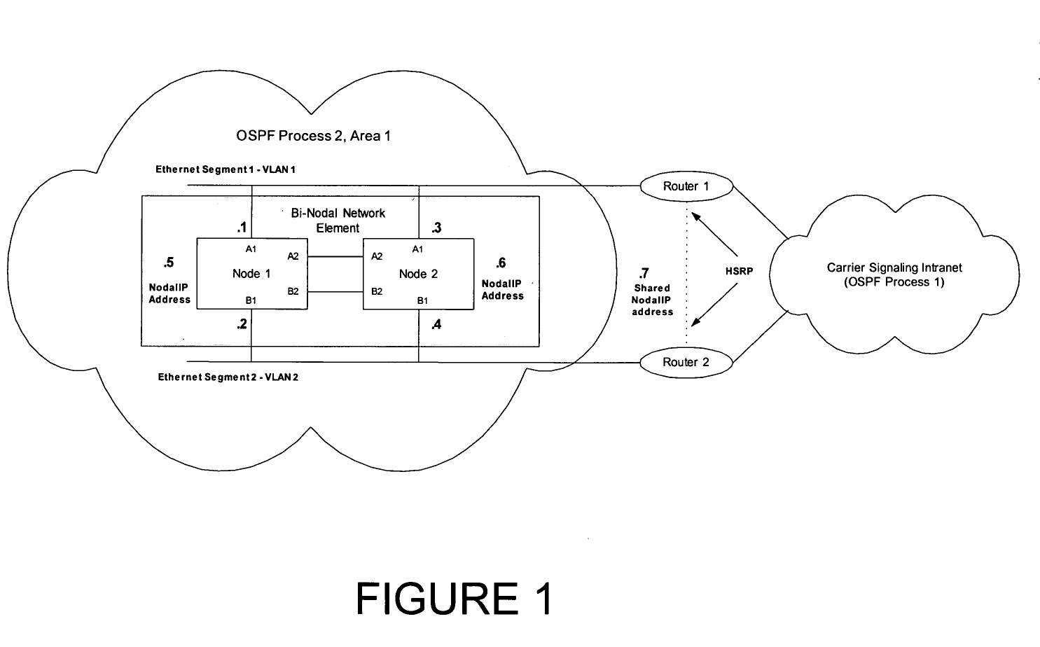

FIG. 1 illustrates an exemplary system in accordance with one embodiment of the present invention. The system includes a bi-nodal network element coupled to a carrier signaling intranet via a redundant router group utilizing OSPF. The bi-nodal network element includes two nodes, Node 1 and Node 2. The bi-nodal network element can be any type of network element, such as a dispatch communication processor (e.g., a highly available Dispatch Application Processor), integrated voice processing unit (iVPU)/transcoder, components of a base station controller, or the like.

The nodes can be arranged to provide redundancy and availability, such that one node is in an active state and the other node is in a standby state with internal node-to-node reachability via the A2 and B2 bi-nodal network element interfaces. This allows independent node failover across the carrier network for the case of individual node isolation due to multiple failure (e.g., failure of Node 1 interface A1 and Node 2 interface B2 failure). Alternatively, or additionally, the nodes can be arranged in a load balancing arrangement, such that when the node in the active state reaches its capacity limits, the other node enters an active state to handle the additional load on the bi-nodal network element through node-to-node communications across the A2 and/or B2 interfaces. Although exemplary embodiments of the present invention are described in connection with a bi-nodal network element, the present invention is equally applicable to network elements with more than two nodes.

Each node includes two ports which share a nodal IP address. Specifically, Node 1 has ports 0.1 and 0.2, which share the nodal IP address of 0.5. Similarly, Node 2 has ports 0.3 and 0.4, which share nodal IP address 0.6. The individual ports require IP addresses for bi-nodal network element internal use. In accordance with exemplary embodiments of the present invention, Node 1 and Node 2 share IP address 0.7. Accordingly, packets originating from either node will use the 0.7 IP address as the source address, and packets destined for either node will use the 0.7 IP address as the destination address for delivery to the active node. The carrier network does not need to know which node is active because the 0.7 IP address is shared between the nodes.

The bi-nodal network element provides services to the communication carrier signaling intranet. For example, if the bi-nodal network element is a dispatch communication processor, the services can be those related to supporting dispatch communications. The carrier signaling intranet can be an intranet supporting a wireless or wired network. In the system of FIG. 1, Routers 1 and 2 are arranged in a redundant relationship, and operate according to hot standby router protocol (HSRP) for Ethernet segments 1 and 2. HSRP is a redundant router protocol that is proprietary to Cisco Systems, Inc., and which allows the use of a single address for a pair of routers.

In the system of FIG. 1, the bi-nodal network element and the carrier signaling intranet operate using Open Shortest Path First (OSPF) routing protocol. Specifically, OSPF process 1 and 2 exist on the carrier router, i.e., Router 1 and Router 2. OSPF process 1 is the backbone routing process and OSPF process 2 is the local OSPF process for the bi-nodal server. OSPF process 2 has two OSPF Areas, Area 0 contains both router loopback interfaces and Area 1 contains the bi-nodal host. Router 1 and Router 2 act as Autonomous System Boundary Routers (ASBRs) between the two OSPF processes. A single host route to OSPF Process 2 Area 1 and another route to OSPF Process 2 Area 0 makes Area 1 totally stubby. The phrase “totally stubby” is well-known in the art as a router which has only two routes, one into the specific OSPF Area and another to the OSPF backbone Area 0.

As illustrated in FIG. 1, all IP addressing is divided between two VLANs, or subnets, on two Ethernet segments, i.e., 1 and 2. The 0.7 shared IP address represents nodal IP addresses 0.5 and 0.6, and is also shared between Router 1 and Router 2. IP addressing association of 0.5 and 0.6 with 0.7 is provided by intelligence within the bi-nodal network element. The addressing in the system of FIG. 1 is complicated because it is divided between two VLANs (subnets) on two Ethernet segments, i.e., Ethernet Segments 1 and 2.

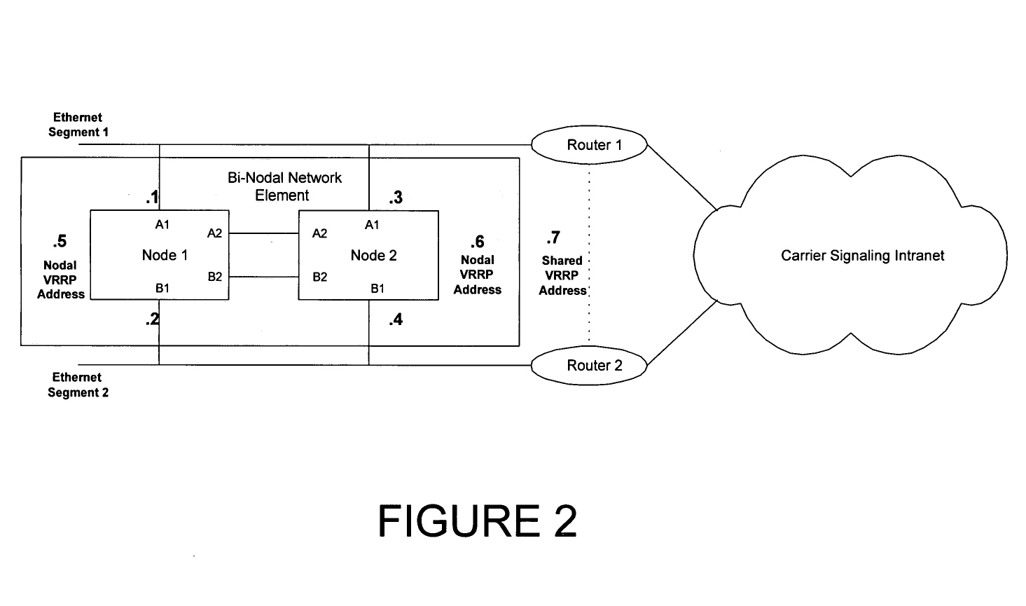

FIG. 2 illustrates an exemplary system in accordance with another embodiment of the present invention. The system of FIG. 2 is similar to that of FIG. 1, except that the routers in the system of FIG. 2 implement VRRP instead of OSPF in combination with HSRP. Similar to the system of FIG. 1, the bi-nodal network element of FIG. 2 is arranged to use a shared address between the two nodes. The arrangement illustrated in FIG. 2 is much simpler than that of FIG. 1 because it does not require Router 1 and Router 2 to support both the backbone routing process and the local OSPF process for the bi-nodal server.

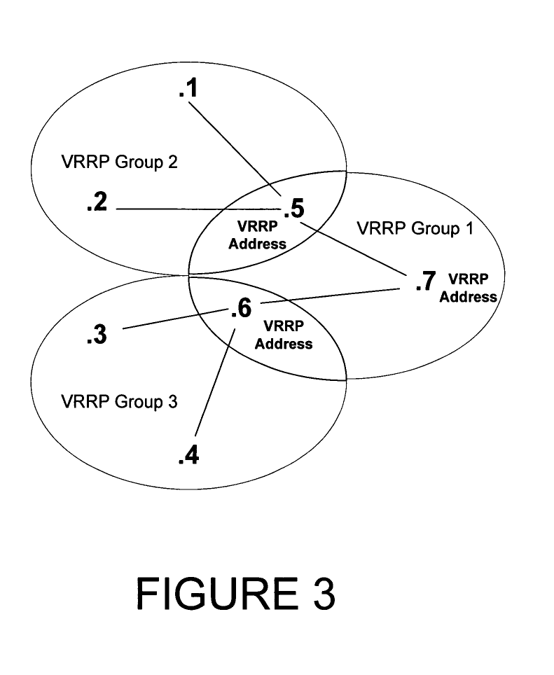

FIG. 3 illustrates a logical view of the virtual router redundancy protocol groups in accordance with exemplary embodiments of the present invention. As illustrated in FIG. 3, all IP addressing is within the same VLAN (subnet). Accordingly, a single IP address, i.e., 0.7, can be advertised to the carrier's signaling intranet to allow access to the bi-nodal network without requiring specific host routes to the individual bi-nodal network element nodes (thus saving router memory and processing capability). This eliminates dependence upon the carrier signaling intranet for redundancy because the bi-nodal network element handles routing of packets to the appropriate destination node.

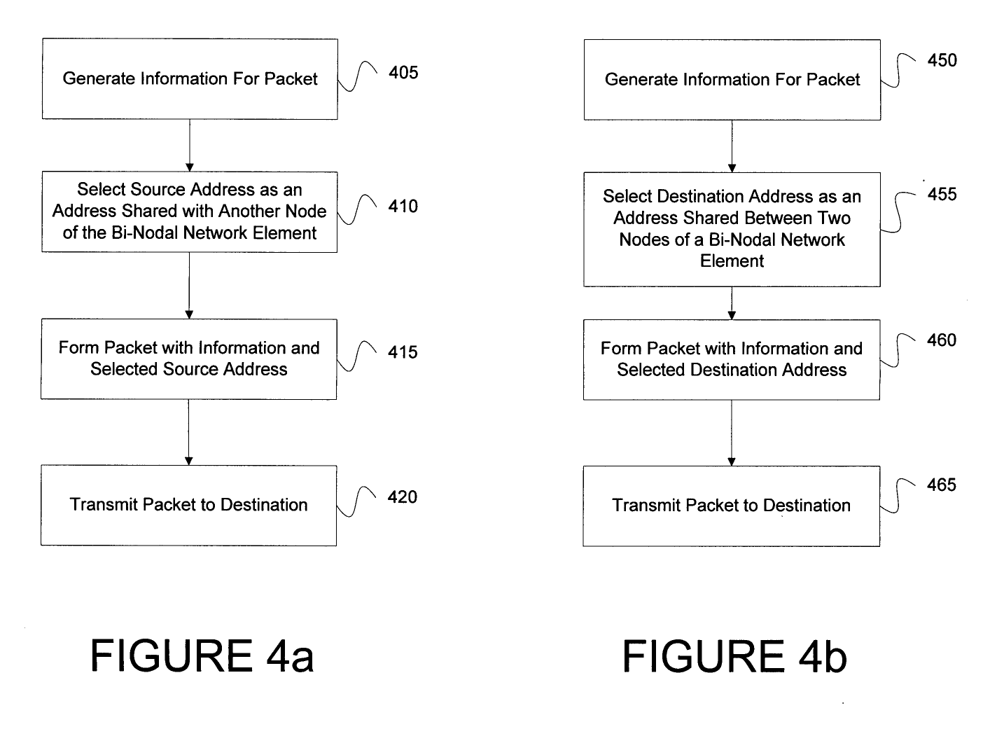

FIGS. 4a and 4b illustrate exemplary methods for communicating with a bi-nodal network element in accordance with the present invention. Specifically, FIG. 4a illustrates an exemplary method for a bi-nodal network element and FIG. 4b illustrates an exemplary method for a network element in a carrier signalling intranet to communicate with a bi-nodal network element. When one of the nodes of the bi-nodal network elements generates information for a packet (step 405), the node selects the shared address of the bi-nodal network element as the source address (step 410). The node then forms the packet using the selected source address and the generated information (step 415), and transmits the packet to the desired destination (step 420).

When a network element desires to transmit a packet to one of the nodes of the bi-nodal network element, the network element generates the information desired to be transmitted (step 450) and selects the destination address of the packet as the shared address of the bi-nodal network element (step 455). The network element then forms a packet using the destination address and the generated information (step 460), and transmits the packet to the bi-nodal network element (step 465).

The present invention provides the ability of the network to receive packets from any one of four host Fast Ethernet interfaces to be advertised for reachability into the redundant router topology. The present invention also provides the ability of the network to be the failover point for a bi-nodal network element in the case of multiple failures of the bi-nodal network element, thus providing increased availability from the supporting network design. The present invention also allows isolation of the bi-nodal network element routing from the carrier network to mitigate any impacts of the bi-nodal network element routing failure, bi-nodal network element malfunction (software error, insanity, etc.), and/or security breach to the host (e.g., hacking from the carrier network).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for communicating with a bi-nodal network element, which includes a first and second node, the method comprising the acts of:
generating, by a first node, information for a packet;
forming, by the first node, the packet, wherein the packet includes the information and a source address, and wherein the source address is an address shared between the first and second nodes.

2. The method of claim 1, wherein the bi-nodal network element is located in a first network, the method further comprising the act of:
transmitting the packet to an entity in a second network.

3. The method of claim 1, wherein the bi-nodal network element is a dispatch communication server.

4. The method of claim 1, wherein the bi-nodal network element is a interactive voice processing unit.

5. The method of claim 1, wherein the bi-nodal network element is located in a first network, the method further comprising the acts of:
receiving a packet from a second network, wherein a destination address of the packet received from the second network is the address shared between the first and second nodes.

6. The method of claim 1, wherein the first node is in an active state and the second node is in a standby state.

7. The method of claim 6, wherein when the first node enters a standby state, the second node enters an active state.

8. A method for communicating with a bi-nodal network element, which includes a first and second node, and which is located in a first network, the method comprising the acts of:
generating, by an element in a second network, information for a packet;
forming, by the element, the packet, wherein the packet includes the information and a destination address, and wherein the destination address is an address shared between the first and second nodes.

9. The method of claim 8, further comprising the act of:
transmitting the packet to the first network.

10. The method of claim 8, further comprising the acts of:
receiving, by a first router, the packet; and
forwarding, by the first router, the packet to the bi-nodal network element.

11. The method of claim 10, wherein the destination address is a logical address and the first and second nodes each have a different physical address.

12. The method of claim 11, wherein the logical address and the different physical addresses are Internet Protocol (IP) addresses.

13. The method of claim 10, further comprising the act of:
receiving the packet by whichever one of the first and second nodes is in an active state.
